(19) United States
(12) Patent Application Publication
(10) Pub. No.: US 2017/0032615 A1
(43) Pub. Date: Feb. 2, 2017

(54) METHOD AND APPARATUS FOR AN INTERACTIVE GAME ASSOCIATED WITH A LIVE SPORTING EVENT

(71) Applicant: Stanley Carswell, Milford, CT (US)

(72) Inventor: Stanley Carswell, Milford, CT (US)

(21) Appl. No.: 14/812,420

(22) Filed: Jul. 29, 2015

(51) Int. Cl. G07F 17/32

(52) U.S. Cl. CPC G07F 17/3246; G07F 17/3288

(57) ABSTRACT

A method for an interactive game associated with a live sporting event, the method comprising: players pay an amount into a bank, thereby creating a pot; banker randomly distributes tickets to players; players watch game; when a team scores, the player holding the ticket of scoring entity wins the pot; start a new round by going back to the players pay an amount into a bank act. An interactive game associated with a live sporting event, the game comprising: a set of tickets for a first round, the set of tickets comprising: an offensive player ticket for a first team in the live sporting event; a defensive team ticket for the first team; an offensive player ticket for a second team in the live sporting event; a defensive team ticket for the second team; and where each ticket has prominently marked on it “1” for the first round; a set of tickets for a second round, the set of tickets comprising: offensive player tickets for the first team; a defensive team ticket for the first team; offensive player tickets for the second team; a defensive team ticket for the second team; and where each ticket has prominently marked on it “2” for the second round; a set of tickets for an 3rd round, the set of tickets comprising: offensive player tickets for the first team; a defensive team ticket for the first team; offensive player tickets for the second team; a defensive team ticket for the second team; and where each ticket has prominently marked on it “3” for the third round; a set of tickets for each round after the third round up to a final desired round, where each set of tickets comprise: offensive player tickets for the first team; a defensive team ticket for the first team; offensive player tickets for the second team; a defensive team ticket for the second team; and where each ticket of a set for a particular round has prominently marked on it the number for the particular round for the particular set of tickets.

### TECHNICAL FIELD

This invention relates to interactive games. More specifically, the invention relates to an interactive game that is associated with a live sporting event.

### BACKGROUND

Sporting events have unpredictable outcomes. However, because of rules and other factors, the outcome and other events within the broadcast are derived from a known set. For example, a football game has events within a game that are derived from a known set. Each game may or may not have a touchdown, interception, field goal, or blocked punt, among various events. In addition, the rules are often established such that one of the two teams must win, although which one is unknown at the beginning of the game. Similarly, other broadcast television sporting events may have an associated set of possible events, although the occurrence of any one of the possible events and the outcome are unknown.

Other games have attempted to create interactivity with sports events. Often, these games require ongoing network access and expensive equipment. In addition, the games limit interactivity among players. The interaction is typically limited to comparison of scores.

Known board and card games are not customized for live broadcasts. They are limited by their original form and therefore are limited in how they relate to a specific broadcast or event.

As such, many interactive games suffer from deficiencies in interactivity among players and with live sporting events. Therefore, an improved live event interactive game would be desirable.

Thus there is a need for an invention that overcomes the above listed and other disadvantages.

### SUMMARY OF THE INVENTION

The disclosed invention relates to a method for an interactive game associated with a live sporting event, the method comprising: players pay an amount into a bank, thereby creating a pot; banker randomly distributes tickets to players; players watch game; when a team scores, the player holding the ticket of scoring entity wins the pot; start a new round by going back to the players pay an amount into a bank acct.

The disclosed invention also relates to an interactive game associated with a live sporting event, the game comprising: a set of tickets for a first round, the set of tickets comprising: offensive player tickets for a first team in the live sporting event; a defensive team ticket for the first team; offensive player tickets for a second team in the live sporting event; a defensive team ticket for the second team; and where each ticket has prominently marked on it “1” for the first round; a set of tickets for a second round, the set of tickets comprising: offensive player tickets for the first team; a defensive team ticket for the first team; offensive player tickets for the second team; a defensive team ticket for the second team; and where each ticket has prominently marked on it “2” for the second round; a set of tickets for an 3rd round, the set of tickets comprising: offensive player tickets for the first team; a defensive team ticket for the first team; offensive player tickets for the second team; a defensive team ticket for the second team; and where each ticket has prominently marked on it “3” for the third round; a set of tickets for each round after the third round up to a final desired round, where each set of tickets comprise: offensive player tickets for the first team; a defensive team ticket for the first team; offensive player tickets for the second team; a defensive team ticket for the second team; and where each ticket of a set for a particular round has prominently marked on it the number for the particular round for the particular set of tickets.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a flow chart showing one method of the invention;

FIG. 2 shows a sheet of tickets;

FIG. 3 shows the back side of the sheet of tickets from FIG. 2;

FIG. 4 shows one embodiment of a ticket;

FIG. 5 shows the back side of the ticket from FIG. 4;

FIG. 6 shows one embodiment of a ticket;

FIG. 7 shows the back side of the ticket from FIG. 6;

FIG. 8 shows the wrapper, and

FIG. 9 shows a sheet of tickets with perforations.

### DETAILED DESCRIPTION

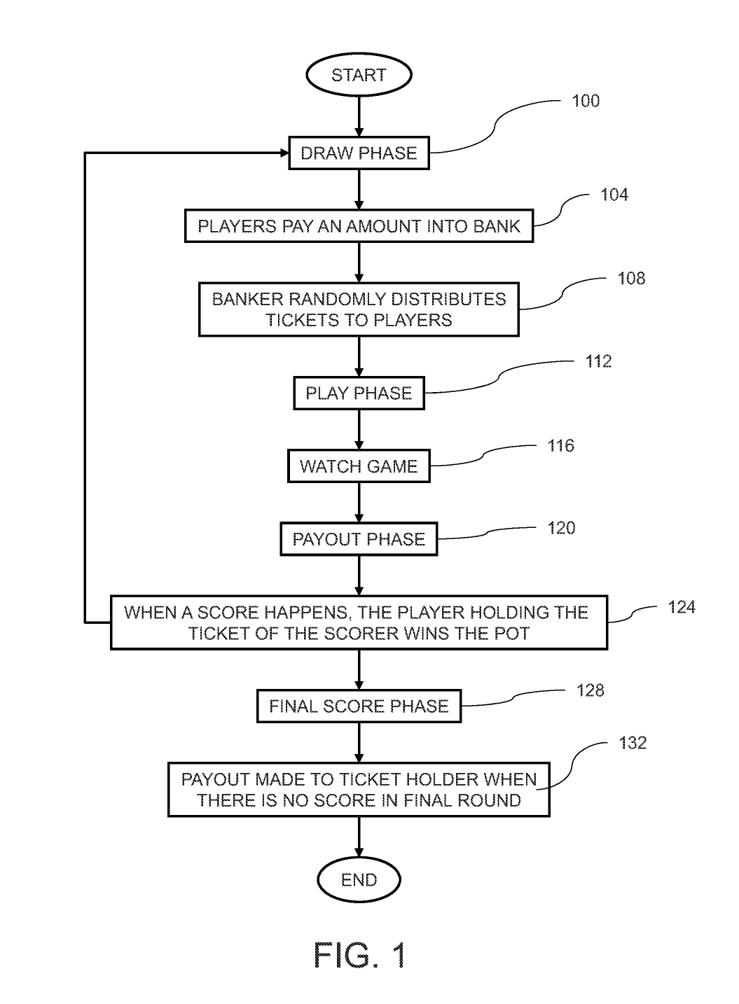

FIG. 1 is a flowchart showing one embodiment of the disclosed interactive game associated with a live sporting event. At act 100, is the beginning of the draw phase. The draw phase comprises the players paying a pre-established amount into a bank at act 104. The amount can be any suitable amount, such as but not limited to 50 cents, $1, $5, etc. At act 108 the banker randomly distributes tickets to the players who have paid into the bank. The play phase starts at act 112. The play phase comprises the players watching the living sporting event, such as but not limited to a football game. At act 120, the payout phase begins. When a score happens, the player holding the ticket with the scorer on it, wins the pot (e.g. the amount placed into the bank for the current round, or a percentage of the amount placed into the bank for the current round), at act 124. The round has ended when a team scores, and the game goes back to the draw phase at act 100. At the end of the sporting event, there may be no score at the last round (the sporting event may run out of time before a score occurs). In one embodiment, there may be a final score phase at act 128. If there is no score at the end of the game, then a payout may be made to a particular ticket holder based on pre-arranged rules, e.g. a random selection of the ticket holders, holder of the MVP player ticket, etc. In a virtual embodiment of the disclosed interactive game associated with a live sporting event, rather than using physical tickets, virtual tickets may be used. Thus, when a player pays his or her money to the bank, an app on the banker's smart device may send a virtual ticket through a network to the player's smart device. The app then can alert the player and the banker as to who won the round. In another embodiment of the virtual embodiment, payment may be made through an online payment system, such as PayPal. Upon winning the round, the player may receive payment via an online payment system. The disclosed interactive game associated with a live sporting event may be played for no money, for ‘tokens’, tickets, prizes, etc.

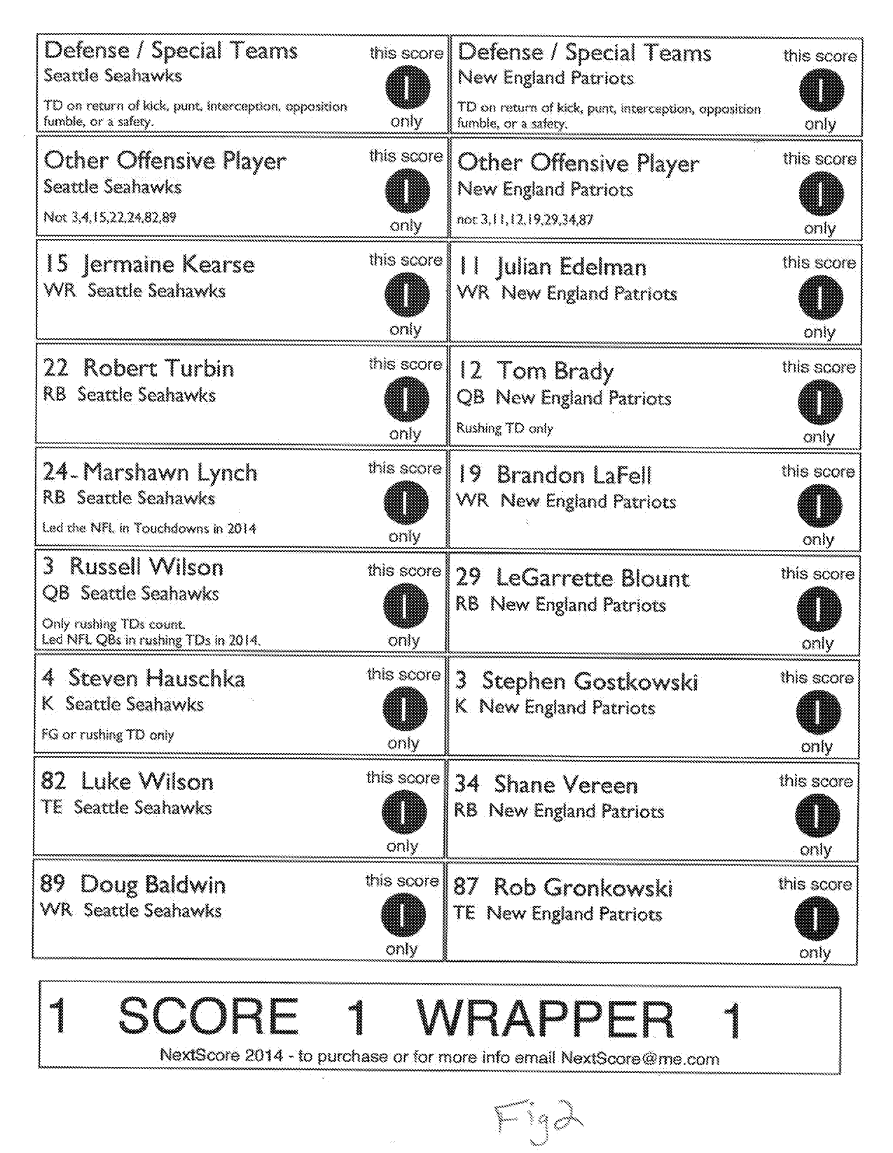

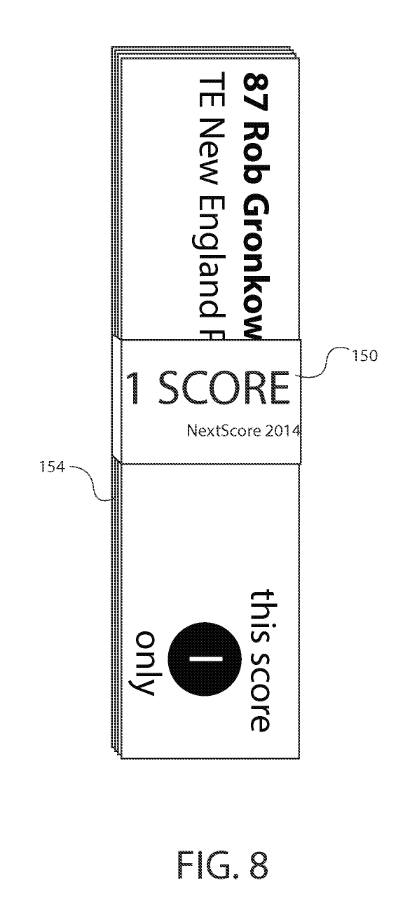

FIG. 2 shows one embodiment of a sheet of tickets for round 1 of the disclosed interactive game associated with a live sporting event. In this example, the sporting event is a football game between the Seattle Seahawks and the New England Patriots. The first column shows 9 tickets associated with Seattle Seahawks players, defense, and/or special teams. The second column shows 9 tickets associated with New England Patriots players, defense, and/or special teams. In this embodiment, one can see for the defense/special teams tickets how the holder of the ticket can win the round: TD on return of kick, punt, an interception, opposition fumble, or a safety. The other offensive player ticket lists players that are not included in the “other offensive player” group, in other words, those players listed under the “Not” label, do not include offensive players who have their own tickets, for instance No. 3 is Russel Wilson, the QB for the Seattle Seahawks. Some of the tickets may have some interesting information, such as for Marshawn Lynch, his ticket says “Led the NFL in Touchdowns in 2014”. Some tickets may specify how the ticket may win, for instance for the Kicker Steven Hauschka, only a field goal or rushing TD will score, or for Tom Brady, only rushing touchdown will score. In one embodiment of the disclosed interactive game, the interactive game does not reward the player who throws a touchdown pass (which is in opposition to normal fantasy football scoring practice.) In one embodiment of the disclosed interactive game, the scorer is the player who crosses the goal line with the football, or is otherwise credited with the score (as is the case when the kicker makes a field goal.) At the bottom of the sheet on FIG. 2, there is a rectangle labeled “1 SCORE 1 WRAPPER 1”. This rectangle can be cut out, along with all the tickets shown. The rectangle may be used as a wrapper to wrap around all the 18 tickets, and the label shows it is for the first round (i.e. the “1”). See FIG. 8 showing the wrapper wrapped around the 18 tickets.

FIG. 3 is a rear view of the sheet of tickets from FIG. 2. Each ticket may have player/team statistics printed on the rear for the player/team shown on the front of the ticket by year, which may be interesting to the players of the disclosed interactive game associated with a live sporting event. Some of the statistics that may be shown on the back of the tickets include: passing yards (PaYds), passing touchdowns (PaTDs), rushing and receiving yards (RuReYds), rushing and receiving touchdowns (RuReTDs), field goal attempts (FGA), field goals completed (FGM), yardage for longest kick (FGLong).

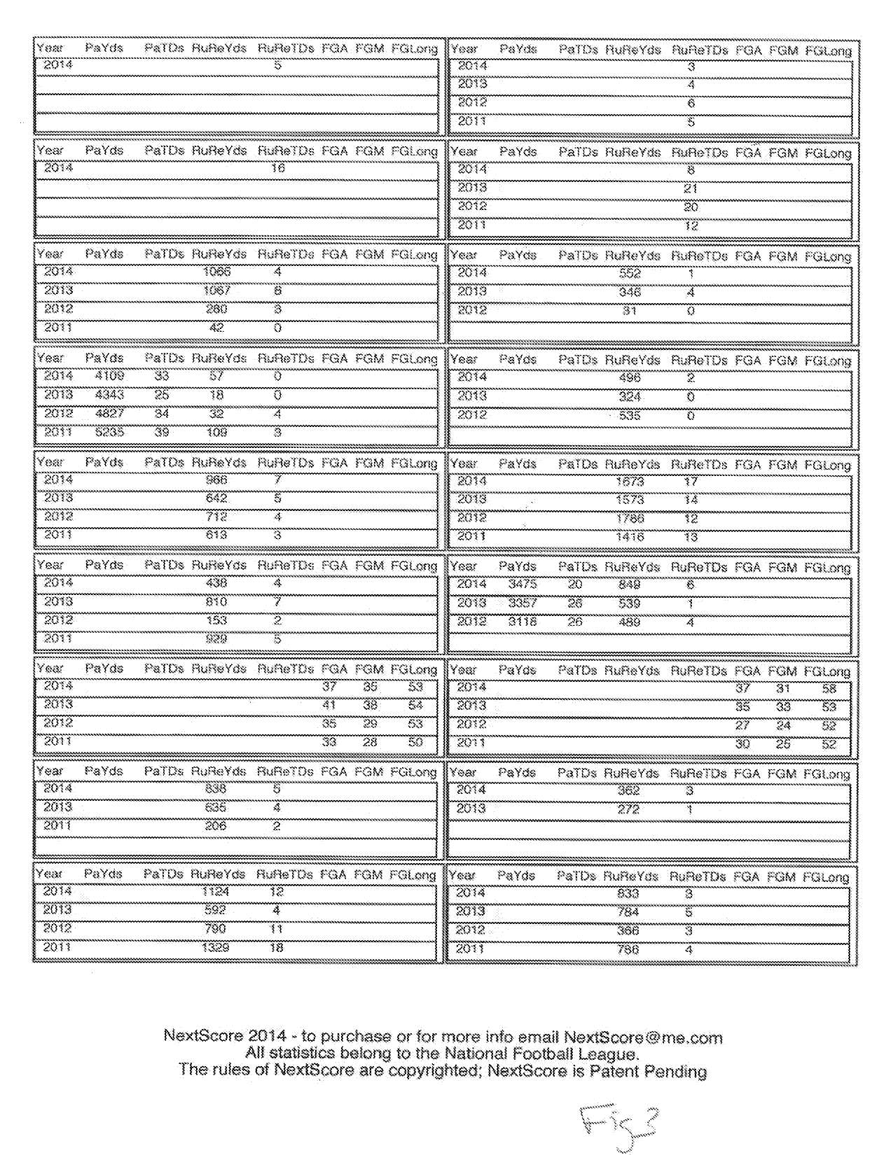

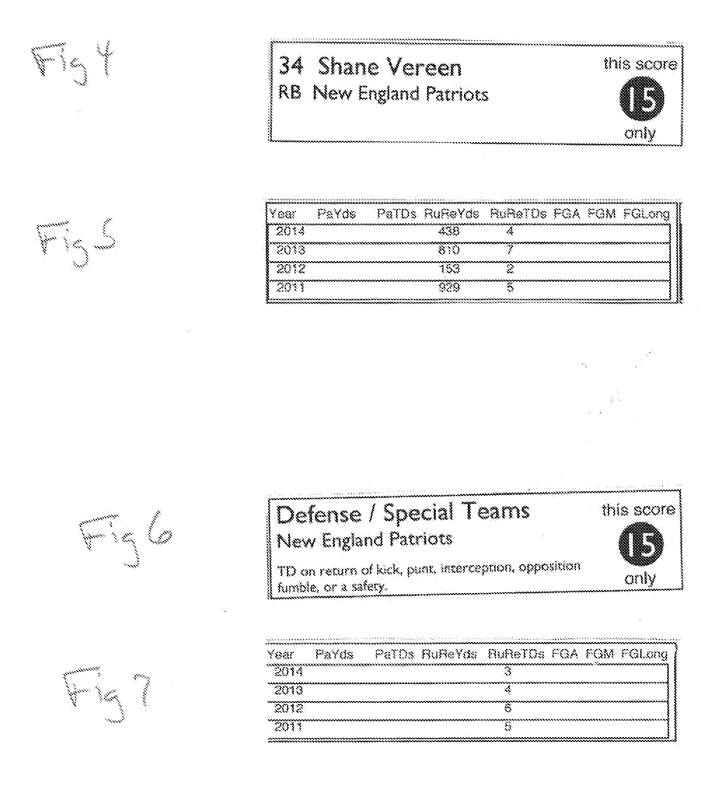

FIG. 4 shows an example ticket for Shane Vereen, number 34 a running back for the New England Patriots, at round 15. FIG. 5 shows the rear of the ticket from FIG. 4. Some data has been pre-printed on the back of the ticket: rushing and receiving yards for years 2011-2014, and Rushing and receiving touchdowns for 2011-2104.

FIG. 6 shows an example ticket for the New England Patriots, defense/special teams.

At the bottom of the ticket, the way the ticket wins is shown as “TD on return of kick, punt, intercept, opposition fumble, or a safety”. The ticket is a round 15 ticket. FIG. 7 shows the rear of the ticket from FIG. 6, with some data pre-printed, namely the rushing and receiving touchdowns for years 2011-2014.

FIG. 8 shows the rectangle from FIG. 2 being used as a wrapper 150, to wrap and hold the 18 tickets 154.

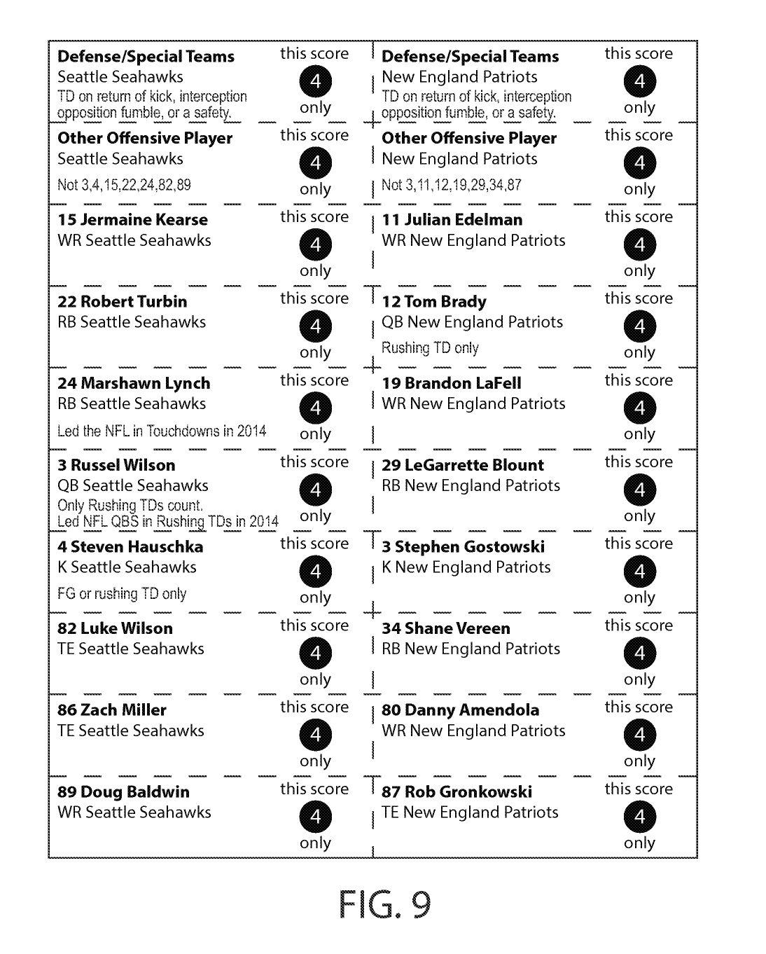

FIG. 9 shows an embodiment of the sheet of tickets, but with perforations represented by the dashed lines. In this embodiment, the banker or other person can simply tear the perforations and put tickets in hat (or otherwise randomly distribute tickets) immediately prior to a round starting or when a new round starts. The rear of the sheet of tickets may have the information as discussed with respect to FIG. 3.

A football game may generally have about 10-11 rounds. Each sheet of pre-printed tickets, and/or pre-printed perforated tickets may correspond to one round. In one embodiment, 15 sheets, corresponding to a possible 15 rounds of play, may be purchased by a user.

The disclosed interactive game associated with a live sporting event is similar to a random lottery, familiar to most people. More specifically, the disclosed interactive game associated with a live sporting event comprises of a series of rounds, each of which generally concludes with a score in the event being watched. Each round comprises of a series of phases: the ‘draw’, the ‘play’, the ‘payout’, and at the end of the event, the ‘final score’. At the start of each round is the ‘draw’ phase, where the ‘banker’ randomly distributes a specific set of tickets to the players. Some specifics of distribution are at the banker's discretion, but playing by the standard rules, the tickets are put in a hat and drawn at random by the players, with a nominal sum of money ($1, for example) put into the ‘bank’ for each ticket drawn. To use the example of the disclosed interactive game associated with a live sporting event while watching a Football game, there may be 18 or 20 (or any other suitable number of) tickets, featuring key offensive players from each side in a particular football game: each team's quarterback, kicker, running backs, tight ends and wide receivers would be represented, plus a ticket for each team's defense, and another “other offensive player” to cover all players on each team not represented individually on a ticket. This concludes the ‘draw’ phase of the game. The next phase, ‘play’, comprises watching the sporting event. The changing allegiances created by the randomly drawn tickets cause the disclosed interactive game players to experience the event from numerous points of view, and to interact with their co-players in different ways during each round. This is the core of the game. The next phase, ‘payout’, happens when a score takes place in the sporting event—in this case in the football game being watched. The disclosed interactive game associated with a live sporting event player with the ticket representing the football player who scores wins the ‘bank’ that was collected during the ‘draw’ phase. Immediately after the ‘payout’ phase, the ‘draw’ phase is repeated, using a new set of tickets. The tickets clearly indicate which round they are for, with tickets marked “1” used for the first round, “2” for the second round, and so-on. This is to ensure that winners are rewarded appropriately, and also to allow each the disclosed interactive game associated with a live sporting event player to receive a different random selection with each draw, enhancing the variety of the viewing experience.

There are variations based on the type of sporting event—number of tickets, especially, but also in some games (such as Hockey for example) there may be almost no tickets for individual players, but rather the tickets are for groups of players (first line, second line, defensemen, etc.)

There is also a ‘final score’ at the end of the sporting event. For events which do not end with a score at the end of the game, it is common for the disclosed interactive game associated with a live sporting event players to be left holding tickets from a ‘draw’ phase which was not followed by a ‘payout’ phase. There is a special ‘payout’ phase in this case (called the ‘final score’) based on rules specific to the sport being played. In some cases the ‘final score’ rule is based on the specific game. For example, in the disclosed interactive game associated with a live sporting event Super Bowl Edition, the ‘final score’ payout goes to the holder of the ticket for the winner of the Super Bowl MVP award, which is announced immediately after the game.

One embodiment of the disclosed interactive game associated with a live sporting event is the NFL ‘standard package’, covering all 51 night games on the NFL schedule in a season. Other packages may not have all of these components, but the ‘standard package’ has all the elements of the disclosed interactive game associated with a live sporting event design. Other embodiments may include the day games. Other embodiments may include college football, and other sports such as basketball, hockey, soccer, baseball, rugby, cricket, etc.

Upon purchase of the NFL ‘standard package’, the customer receives the disclosed interactive game associated with a live sporting event Game Kit, comprising a pre-set number of sheets of the disclosed interactive game associated with a live sporting event perforated card stock (there are several sizes, all customized for individual game types, in some cases with pre-printed ‘security bordering’ as indicated by the customer), several printed rule sheets for distribution to players, a graphical rule poster for mounting on a wall, a dry-erase ‘score board’ (pre-printed for our purposes) and dry-erase marker. The number of sheets of perforated stock is calculated to be enough to last for the entire subscription. In the case of the NFL ‘standard package’, the customer receives 600 sheets. Refills can be ordered separately. Other than the disclosed interactive game associated with a live sporting event branding and optional security features, the stock is blank.

On a regular basis, beginning about four days prior to the first game covered by the subscription, the customer will receive formatted documents via email (which can also be retrieved from our server, as a backup), which are to be used to print up the tickets, using the pre-supplied card stock. Each sheet will have player information, including uniform color and number, name, and some basic statistics and other information. Each document will indicate how many rounds are expected for the game in question, and will provide guidelines regarding how many sheets should be printed.

In case of sudden roster changes prior to games, additional forms may be sent by email so that customers can use up-to-date tickets in their games.

Customers have the option of specifying text to go on every ticket—“Harry's Bar” or “Happy Birthday John”, for example.

The disclosed interactive game associated with a live sporting event has many advantages. The disclosed interactive game associated with a live sporting event is a game designed for entertainment purposes. It is designed to enhance the experience of watching a team-based sporting event (such as a football, hockey or baseball game) on television. The disclosed interactive game associated with a live sporting event makes even the dullest game entertaining, through giving the player a stake in the next score (or lack thereof) made in the game. Unlike fantasy (football, baseball, soccer, etc.) leagues and games, the disclosed interactive game associated with a live sporting event is based on the random assignment of individual players and/or groups of (athlete) players to the disclosed interactive game associated with a live sporting event players, and each round in the game is decided by the individual scores in the sporting event being watched. Scoring is done in real-time along with the scoring in the televised event, and the disclosed interactive game associated with a live sporting event players receive a new random assignment with each round they play. You can view each score in the game being watched as a separate ‘round’ or ‘game’ of the disclosed interactive game associated with a live sporting event, in the same sense that a winning ‘hand’ of poker can be viewed as completion of a ‘game’ within, say, an evening's sitting.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A method for an interactive game associated with a live sporting event, the method comprising:
players pay an amount into a bank, thereby creating a pot;
banker randomly distributes tickets to players;
players watch game;
when a team scores, the player holding the ticket of scoring entity wins the pot;
start a new round by going back to the players pay an amount into a bank account.

2. The method of claim 1, wherein the tickets are virtual tickets and the banker randomly distributes the tickets via a network to each player's smart device.

3. The method of claim 1, wherein the players pay an amount into a bank via an online payment system, and wherein when a player wins a pot, payment is made to the player via an online payment system.

4. The method for an interactive game associated with a live sporting event of claim 1, further comprising:
paying the holder of a pre-selected ticket the final pot when there is no score in the final round.

5. The method for an interactive game associated with a live sporting event of claim 1, wherein the tickets comprise: a defense/special teams ticket for a first team in the live sporting event; an other offensive player ticket for the first team, a wide receiver ticket for the first team; a running back ticket for the first team; a second running back ticket for the first team, a quarter back ticket for the first team; a kicker ticket for the first team; a tight end ticket for the first team; a wide receiver ticket for a first team; a defense/special teams ticket for a second team in the live sporting event; an other offensive player ticket for the second team, a wide receiver ticket for the second team; a running back ticket for the second team; a second running back ticket for the second team, a quarter back ticket for the second team; a kicker ticket for the second team; a tight end ticket for the second team; and a wide receiver ticket for the second team.

6. The method for an interactive game associated with a live sporting event of claim 5, wherein the tickets further comprise: a second wide receiver ticket for the first team, a second wide receiver ticket for the second team.

7. An interactive game associated with a live sporting event, the game comprising:
a set of tickets for a first round, the set of tickets comprising:
an offensive player ticket for a first team in the live sporting event;
a defensive team ticket for the first team;
an offensive player ticket for a second team in the live sporting event;
a defensive team ticket for the second team; and wherein each ticket has prominently marked on it “1” for the first round;
a set of tickets for a second round, the set of tickets comprising:
an offensive player ticket for the first team;
a defensive team ticket for the first team;
an offensive player ticket for the second team;
a defensive team ticket for the second team; and wherein each ticket has prominently marked on it “2” for the second round;
a set of tickets for an 3rd round, the set of tickets comprising:
an offensive player ticket for the first team;
a defensive team ticket for the first team;
an offensive player ticket for the second team;
a defensive team ticket for the second team; and wherein each ticket has prominently marked on it “3” for the third round;
a set of tickets for each round after the third round up to a final desired round, wherein each set of tickets comprise:
an offensive player ticket for the first team;
a defensive team ticket for the first team;
an offensive player ticket for the second team;
a defensive team ticket for the second team; and wherein each ticket of a set for a particular round has prominently marked on it the number for the particular round for the particular set of tickets.

8. The interactive game associated with a live sporting event of claim 7, wherein the live sporting event is a football game.

9. The interactive game associated with a live sporting event of claim 7, wherein the live sporting event is a televised sporting event.

10. The interactive game associated with a live sporting event of claim 7, wherein each set of tickets comprise 8, 9, 10, or 11 tickets.

11. The interactive game associated with a live sporting event of claim 7, wherein each ticket has indicia on the back of the ticket indicating statistics for the player or team named on the ticket.

12. The interactive game associated with a live sporting event of claim 7, wherein each set of tickets are printed on a single sheet of material.

13. The interactive game associated with a live sporting event of claim 7, wherein each set of tickets are printed on a single sheet of material, and wherein the material is perforated to allow for quick separation of the tickets.

14. The interactive game associated with a live sporting event of claim 7, wherein the sheet of material is card stock.

15. The interactive game associated with a live sporting event of claim 12, wherein each sheet of material has an indicia labeled “wrapper” and an indicia of the round number associated with the set of tickets on the sheet of material.
